(19) United States
(12) Patent Application Publication
(10) Pub. No.: US 2017/0278545 A1
(43) Pub. Date: Sep. 28, 2017

(54) MEDIA CONTENT MANIPULATION

(71) Applicant: Sugarlock, Inc., Los Gatos, CA (US)

(72) Inventors: Donald Robert Woodward, JR., Los Gatos, CA (US); Mark Allen, Menlo Park, CA (US)

(21) Appl. No.: 15/465,382

(22) Filed: Mar. 21, 2017

Related U.S. Application Data
(60) Provisional application No. 62/311,508, filed on Mar. 22, 2016.

(51) Int. Cl. G11B 27/031; G11B 27/10; G11B 27/34; H04L 12/58

(52) U.S. Cl. CPC G11B 27/031; H04L 51/32; G11B 27/10; G11B 27/34

(57) ABSTRACT

Manipulation of media content is described. In one aspect, a media content device can receive input representing one or both of a beginning or end of a playback time of a portion of media that should be excluded from playback. The media content can then generate a cut list having metadata referencing that the portion should be excluded from playback. The media content can then be played back without playing back that portion based on the metadata.

### CLAIM FOR PRIORITY

This application claims priority to U.S. Provisional Patent Application No. 62/311,508, entitled “Method and Apparatus for Personal Media Manipulation and Enjoyment,” by Allen, and filed on Mar. 22, 2016. The content of the above-identified application is incorporated herein by reference in its entirety.

### TECHNICAL FIELD

The disclosure relates to manipulation of media content, for example, editing media content.

### BACKGROUND

Today, consumers find it difficult to work with video camera content. Files get recorded and stored on memory cards (e.g., micro-secure digital (SD) cards) in the file layout and naming convention that was implemented at the time of the introduction of the first digital photo cameras in the 1990s. Files are nested inside of a cryptically named subdirectory inside of a top-level digital camera images directory often titled “DCIM” and are given cryptic filenames in what appears to the consumer to be an arbitrary numerical sequence. Longer recordings split across multiple extended files. The multiple extended files are named out of numbered sequence in a manner proprietary to the camera manufacturer. Thus, finding the correct file to watch, and then the act of playing it back are extremely time-consuming and difficult, often requiring lengthy transcoding processes. The user, in order to become effective, must absorb a great deal of esoteric knowledge about video file formats and file management.

The user is also required to hook the camera to a PC or Mac computer via a universal serial bus (USB) connection, remove the card from the camera and insert it into a card reader connected to the computer, or use a wireless connection via the use of proprietary software. Once connected, the user has the option of dealing with the files directly, or using software provided by the camera manufacturer to manipulate the files.

The usability of such software is often quite poor, requiring a steep learning curve and presenting a poor user interface that copies and buries the actual files deep within the native file system of the computer. As a result, the full potential of the cameras remains untapped, and the user is left frustrated. Only a small fraction of the content recorded on these cameras ever sees the light of day. Additionally, the content recorded by the cameras can be relatively lengthy and only a fraction of that content might be interesting for the user to show to others.

### SUMMARY

Some of the subject matter described herein includes an electronic device including one or more processors; and memory storing instructions, wherein the one or more processors are configured to execute the instructions such that the one or more processors and memory are configured to: play back a first video; receive input representing one or both of a beginning or end of a playback time of a portion of the first video within a playback time of the first video that should be excluded from playback; generate a cut list including metadata referencing that the portion of the first video should be excluded from playback; and play back the first video without playing back the portion based on the metadata included in the cut list.

In some implementations, a time duration of playback of the portion is less than a time duration of playback of the first video.

In some implementations, the one or more processors are configured to execute the instructions such that the one or more processors and memory are configured to: generate a second video based on the first video and the metadata included in the cut list, the second video excluding the portion of the first video, playback of the second video being shorter in time duration than playback of the first video.

In some implementations, the one or more processors are configured to execute the instructions such that the one or more processors and memory are configured to: publish the second video to one or more of a social media service, a messenger program, email, or text messaging.

In some implementations, the one or more processors are configured to execute the instructions such that the one or more processors and memory are configured to: provide, on a graphical user interface (GUI), a first depiction representing the first video; and provide, on the GUI, a second depiction representing playback of the first video based on the cut list.

In some implementations, the second depiction includes visual content differentiating the second depiction as being based on the cut list in comparison to the first depiction.

Some of the subject matter described herein also includes an electronic device, including: one or more processors; and memory storing instructions, wherein the one or more processors are configured to execute the instructions such that the one or more processors and memory are configured to: receive input representing one or both of a beginning or end of a playback time of a portion of a first media content within a playback time of the first media content that should be excluded from playback; generate a cut list including metadata referencing that the portion of the first media content should be excluded from playback; and play back the first media content without playing back the portion based on the metadata included in the cut list.

In some implementations, the first media content is a video.

In some implementations, a time duration of playback of the portion is less than a time duration of playback of the media content.

In some implementations, the one or more processors are configured to execute the instructions such that the one or more processors and memory are configured to: generate a second media content based on the first media content and the metadata included in the cut list, the second media content excluding the portion of the first media content, playback of the second video being shorter in time duration than playback of the first media content.

In some implementations, the one or more processors are configured to execute the instructions such that the one or more processors and memory are configured to: publish the second media content to one or more of a social media service, a messenger program, email, or text messaging.

In some implementations, the one or more processors are configured to execute the instructions such that the one or more processors and memory are configured to: provide, on a graphical user interface (GUI), a first depiction representing the first media content; and provide, on the GUI, a second depiction representing playback of the first media content based on the cut list.

In some implementations, the second depiction includes visual content differentiating the second depiction as being based on the cut list in comparison to the first depiction.

Some of the subject matter described herein also includes a method for playing back media content, including: receiving input representing one or both of a beginning or end of a playback time of a portion of a first media content within a playback time of the first media content that should be excluded from playback; generating, by a processor, a cut list including metadata referencing that the portion of the first media content should be excluded from playback; and playing back the first media content without playing back the portion based on the metadata included in the cut list.

In some implementations, the first media content is a video.

In some implementations, a time duration of playback of the portion is less than a time duration of playback of the media content.

In some implementations, the method includes generating a second media content based on the first media content and the metadata included in the cut list, the second media content excluding the portion of the first media content, playback of the second video being shorter in time duration than playback of the first media content.

In some implementations, the method includes publishing the second media content to one or more of a social media service, a messenger program, email, or text messaging.

In some implementations, the method includes providing, on a graphical user interface (GUI), a first depiction representing the first media content; and providing, on the GUI, a second depiction representing playback of the first media content based on the cut list.

In some implementations, the second depiction includes visual content differentiating the second depiction as being based on the cut list in comparison to the first depiction.

### BRIEF DESCRIPTION OF THE DRAWINGS

FIG. 1 illustrates an example of generating metadata representing edits to media content.

FIG. 2 illustrates a block diagram for generating metadata representing edits to media content.

FIG. 3 illustrates an example of displaying media content for playback.

FIG. 4 illustrates an example of playing back media content.

FIG. 5 illustrates another example of displaying media content for playback.

FIG. 6 illustrates another example of displaying media content for playback.

FIG. 7 illustrates an example of editing media content.

FIG. 8 illustrates another example of editing media content.

FIG. 9 illustrates an example of a media playback scrub bar with cuts for editing media content.

FIG. 10 illustrates an example of a user interface of a mobile device for editing media content.

FIG. 11 illustrates an example of a media content device.

FIG. 12 illustrates another example of a media content device.

FIG. 13 illustrates an example of a media content device providing playback of media content on a television.

FIG. 14 illustrates a block diagram for cloud-based editing of media content.

FIG. 15 illustrates an example of a media content device.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

This disclosure describes devices and techniques for the manipulation of media content. In one example, a user can record several videos of his or her activities (e.g., a hike, whitewater rafting, wingsuit flying, etc.) using an action camera. Often, these videos might include some content during the playback that is more interesting than other content. For example, the user might begin recording while setting up for a wingsuit flight, jump off a cliff or platform, glide through the air, and then land before turning off the recording. Thus, the playback of the entire video can include many portions having content that is relatively boring or less interesting than other portions. Because of this, users often want to easily and quickly edit the video (e.g., only include the interesting portions of the video for playback) and be able to share that edited video.

As disclosed herein, the user can provide the video to a media content device, for example, via a microSD card or a wireless network. The videos can be played back on a display screen, for example, a television that is communicatively connected with the media content device. Using a touchscreen of a mobile device that is communicatively connected with the media content device, the user can manipulate the playback of the video on the television screen. For example, an application (or “app”) on the mobile device can recognize gestures input from the user on the touchscreen of the mobile device and provide data indicating those gestures to the media content device. The media content device can then adjust playback of the video on the television based on the gestures.

Additionally, the user can edit the video using the media content device. For example, by using the mobile device, portions of the playback of the video can be selected by the user to be “cut” from the playback of the video. This can result in the media content device generating metadata indicating the portions of the playback of the video that should be skipped from playback. Thus, the user can select the interesting portions of a video for playback, the corresponding metadata can be generated, and the metadata can be used to only play back those interesting portions of the video later without generating a new version of the video that only includes those interesting portions. Later, if the user wants to share the interesting portions of the video, a new video can be generated or mastered having only those interesting portions using the metadata.

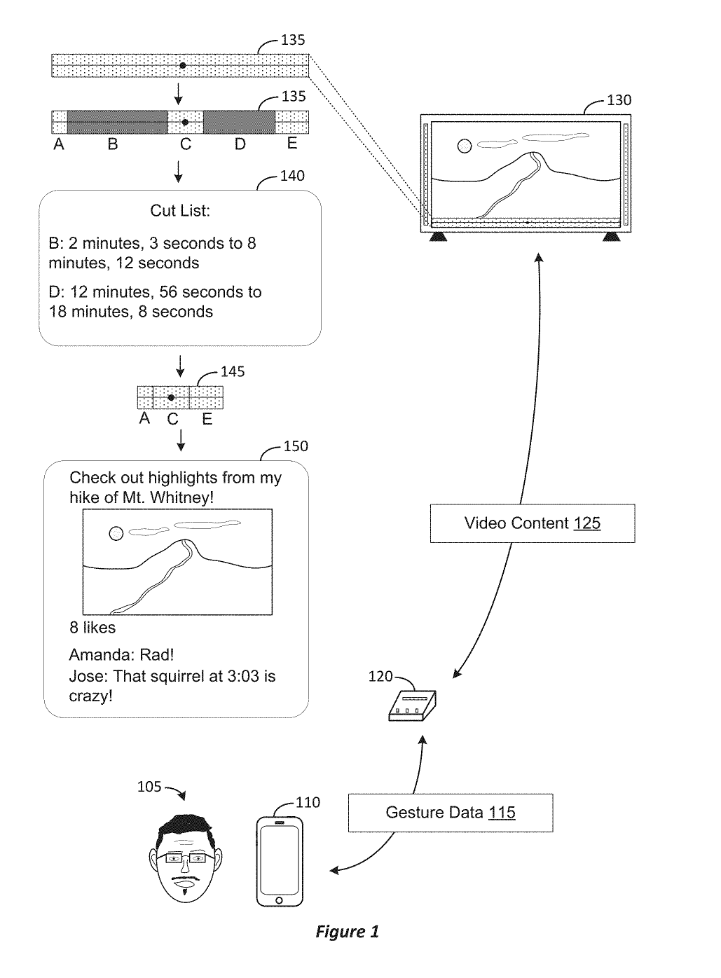

In more detail, FIG. 1 illustrates an example of generating metadata representing edits to media content. In FIG. 1, user 105 can have a video recording of his recent hike to the peak of a mountain. The video might be quite lengthy and include many portions where the visual and audio content merely portray relatively mundane activities during the hike. However, some other portions might include content that is more exciting. For example, if the video is twenty minutes long, then different non-contiguous portions of the video might include content that user 105 can be interested in showing others or even to himself later. For example, the content from the beginning to 2 minutes, 2 seconds can be one portion including interesting content. The next portion including interesting content can be from 8 minutes, 13 seconds to 12 minutes, 55 seconds, and so forth. Thus, playing back those portions (i.e., skipping the playback from 2 minutes, 3 seconds to 8 minutes, 12 seconds) can provide a better user experience for consuming videos.

In FIG. 1, user 105 can provide the video content to media content device 120, for example, via a microSD card, USB cable and card reader, from a mobile device (e.g., smartphone, tablet, etc.), a home network (e.g., a network attached storage (NAS), a computer, etc.), the cloud (e.g., from an online storage service), etc. Media content device 120 can be a device that can play back and edit videos according to metadata generated from the user's interactions, for example, with mobile device 110 (e.g., a smartphone, tablet, or other device with a touchscreen display). Additionally, media content device 120 can share edited videos on a variety of social media platforms.

For example, in FIG. 1, video content 125 can include video (e.g., image frames) and audio (e.g., sounds, speech, music, etc.) data to be played back on television 130. For example, media content device 120 can access videos stored on the microSD card and play back those videos on television 130, for example, if it is connected with a High-Definition Multimedia Interface (HDMI) cable, Digital Visual Interface (DVI), Video Graphics Array (VGA) connector, or other physical cables, or even wirelessly.

As depicted in FIG. 1, scrub bar 135 of the video played back on television 130 represents a timeline for the time duration of the playback of the video. The circle of scrub bar 135 in FIG. 1 represents a playhead indicating the current time in the duration that the playback of the video is within (e.g., the current playback time, such as 8 minutes, 12 seconds into the playback). However, as discussed above, user 105 might want to play back less than the full time duration of the playback of the video. Accordingly, user 105 can use mobile device 110 to indicate portions of the video content 125 that should not be played back.

For example, in FIG. 1, user 105 can use mobile device 110 to select a video to be edited. This results in media content device 120 generating a “cut list” as metadata that represents edits or deviations from the playback of the full video. Because user 105 has not performed any editing yet in this example, the cut list can be relatively empty other than data referencing the video as the original video file that will have a different playback.

When the video is selected, video content 125 can be provided to television 130 so that user 105 can observe the video on a larger screen. Using the touchscreen of mobile device 110, user 105 can manipulate scrub bar 135 of the video player of media content device 120 playing back video content 125 on television 130 to select portions of the playback to be skipped in future playbacks. For example, in FIG. 1, portions A, B, C, D, and E of scrub bar 135 represent different portions of the playback of video content 125 as indicated by the user. User 105 can set “cut points” representing beginnings and/or ends of portions of the video content that should be skipped. For example, in FIG. 1, user 105 has selected cut points indicating that portions B and D should not be played back, resulting in portions A, C, and E as portions that should be played back.

This results in the generation of cut list 140 providing the metadata indicating the portions of the playback that should be skipped, for example, portion B having a playback time from 2 minutes, 3 seconds to 8 minutes, 12 seconds and portion D from 12 minutes, 56 seconds, to 18 minutes, 8 seconds. Alternatively, the metadata indicated in cut list 140 can represent the portions that should be played back (e.g., portions A, C, and E), or even both (e.g., indicate what should be played back and what should not be played back).

Upon the generation of the cut list, media content device 120 can display a second version of the video to user 105 even though the video has not been duplicated. Rather, the cut list is represented in a graphical user interface (GUI) as a video that can be played back. That is, the original video and that same original video having a playback corresponding to the cut list can be presented as two separate videos that can be watched, the original video providing the full duration of the playback and the second one providing the playback shortened based on the cut list. If the video corresponding to the cut list is selected, media content device 120 can use the metadata indicated in cut list 140 to play back the video with only portions A, C, and E and skipping the playback of portions B and D. As a result, user 105 can quickly and easily view and “edit” a video. Because the video did not have to be encoded to only include playback of portions A, C, and E, the editing and playback of less than all of the portions of the video can be quick. This can encourage user 105 to make more use of his videos and further encourage user 105 to use the video recording device.

Additionally, media content device 120 can “share” or provide the interesting portions of the video on other services, for example, social media services or messenger programs such as Facebook®, Instagram®, Twitter®, WhatsApp®, or even email, text messaging, etc. For example, using mobile device 110, user 105 can select that he wants to share a video corresponding to cut list 140. That is, user 105 might want to share a video providing playback of portions A, C, and E and not B and D as indicated by cut list 140. Thus, media content device 120 can then master, or generate, a new video providing playback of just those portions as indicated by scrub bar 145 (providing a playback of a shorter duration than scrub bar 135). Using the account credentials of user 105, the video can then be uploaded to social media feed 150 where the friends of user 105 can comment. In some implementations, the account credentials can be provided to media content device 120 from a mobile device of user 105. For example, if user 105 provides a video stored by mobile device 110 for generating a cut list as discussed above, then the account credentials for social media services or messenger programs can also be provided so that media content device 120 can share the interesting portions of the video. Thus, if a different user then connects his or her device to media content device 120, that user's account credentials can then be provided and videos can be shared on that different user's social media services or messenger programs.

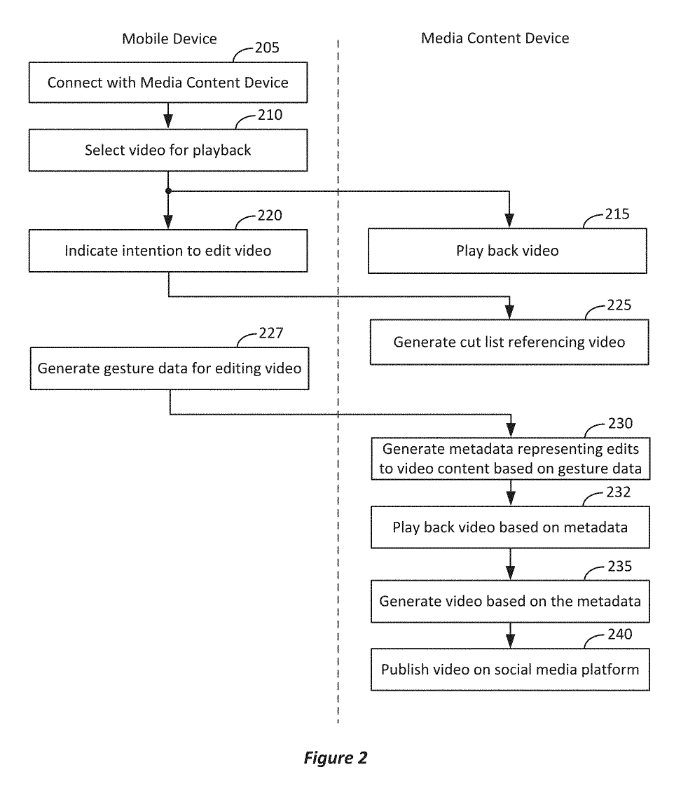

FIG. 2 illustrates a block diagram for generating metadata representing edits to media content. In FIG. 2, a mobile device with a touchscreen can connect with a media content device (205). For example, the user can run an application on a mobile device including a touchscreen that can cause the mobile device to wirelessly connect with the media content device. A variety of wireless technologies can be used, including the IEEE 802.11 standards, Bluetooth®, etc. In some implementations, the media content device can broadcast its own wireless network and the mobile device can connect to that network to be communicatively coupled with the media content device.

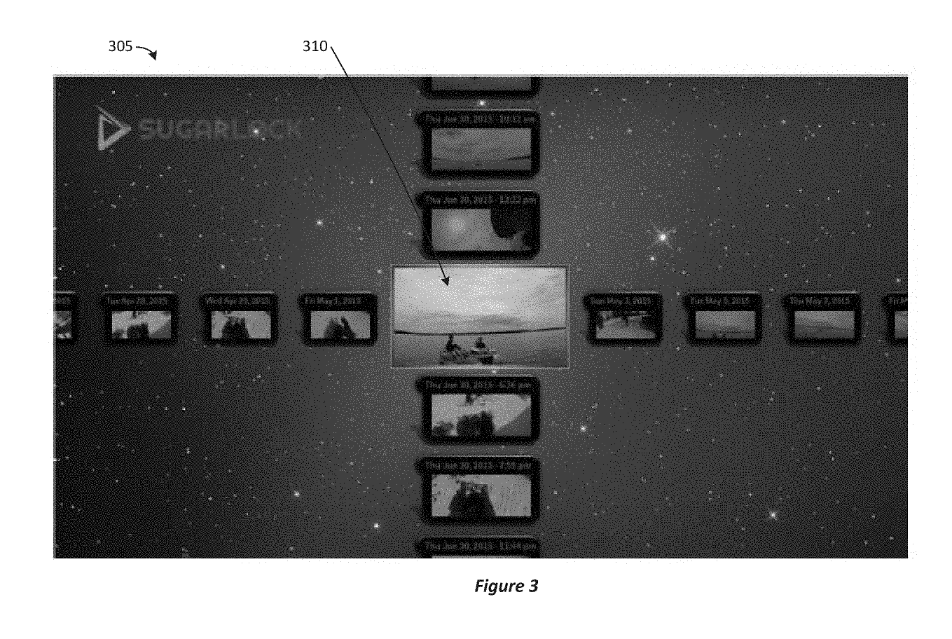

If videos are available to the media content device, for example on a microSD card accessible to it, then the available videos can be displayed in a graphical user interface (GUI) and the user can select a video for playback (210), resulting in the video being played back on a television or other display device connected with the media content device (215). FIG. 3 illustrates an example of displaying media content for playback. In FIG. 3, GUI 305 displays the videos stored on a microSD card or other storage storing videos. In some implementations, GUI 305 is a “main screen” that the user is provided to navigate through the stored videos upon powering up or turning on a media content device. As depicted in FIG. 3, a horizontal bar and a vertical bar each portraying a sequence of image frames are provided. Each image frame can represent a separate video available for playback. In the center of GUI 305, at the intersection of the horizontal and vertical bars, is video 310, which can be playing back. The user can scroll through the horizontal and vertical bars and each new video that results in the intersection can begin play back from that location in GUI 305.

In some implementations, each list within the horizontal bar list represents a single day. For example, in FIG. 3, seven videos might have been recorded on the same day as video 310. On the four days afterwards and four days before, only a single video from each day was recorded. Thus, the image frames are grouped in terms of commonality of time. In some implementations, the videos in the same time range (e.g., same day) can be ordered in sequence in terms of when they were recorded. This can allow for the grouping of videos around events (e.g., all of the videos regarding wingsuit gliding on a particular day would be displayed within the same vertical bar), allowing for a better organization of videos for users rather than being merely provided with a list of videos with cryptic filenames, as previously discussed. The user can drag, swipe, or flick up, down, left, or right on the touchscreen of the mobile device to adjust the video provided in the intersection accordingly. That is, gesture data representing changes that the user wants in GUI 305 can be provided to the media content device to select a video.

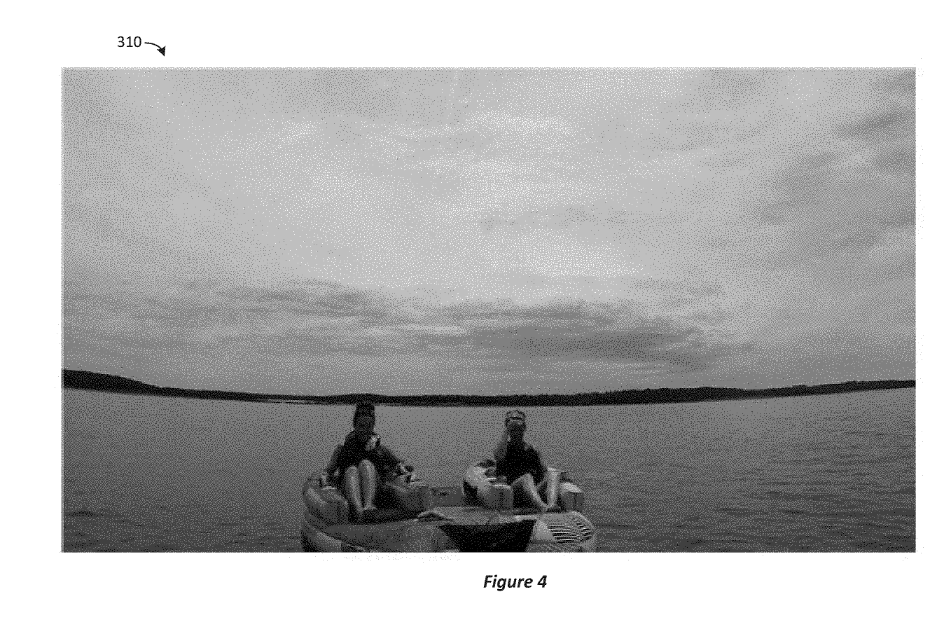

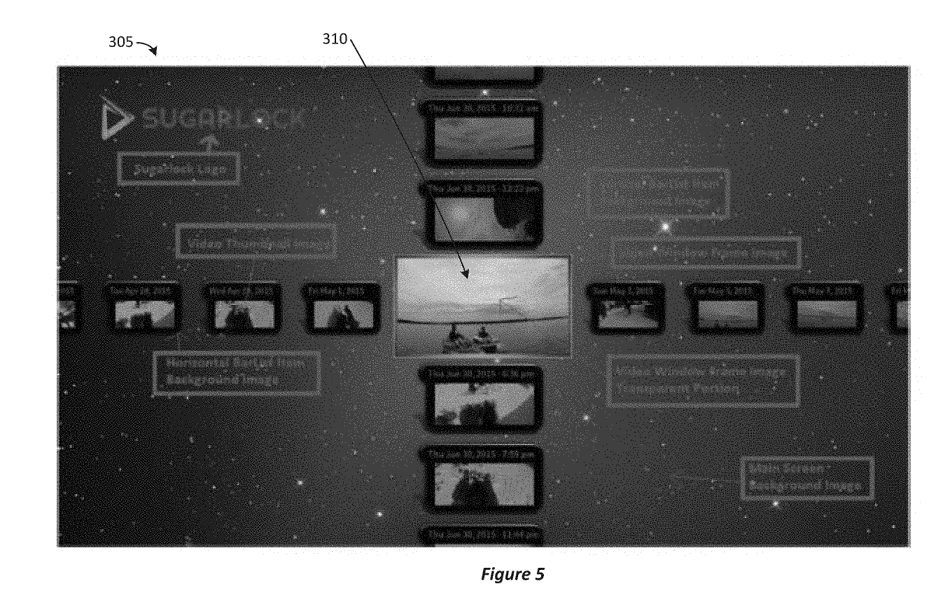

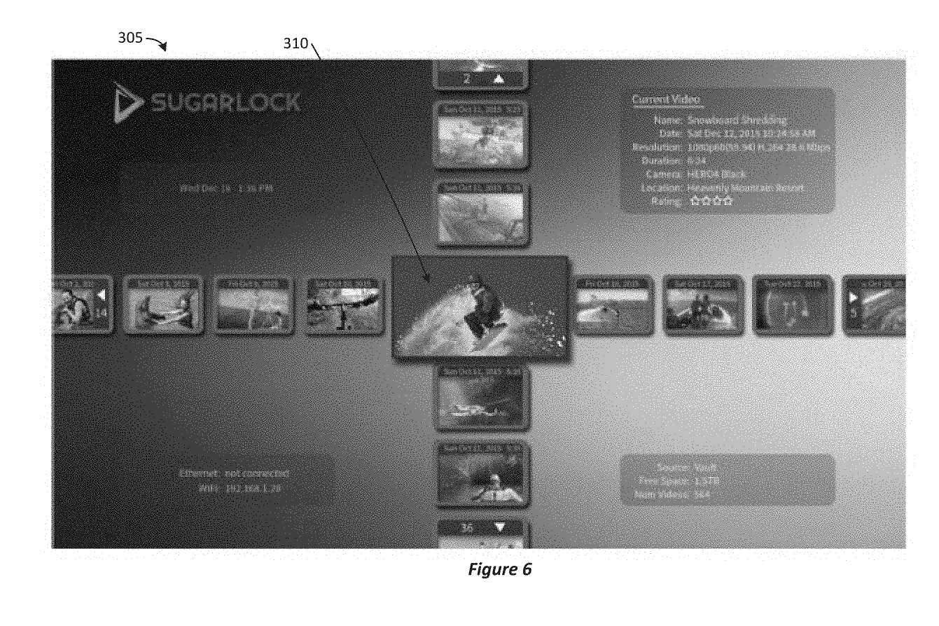

In some implementations, if the user taps the touchscreen of the mobile device, simulating “tapping” video 310, then this can play back video 310 in a full-screen mode. FIG. 4 illustrates an example of playing back media content. In FIG. 4, video 310 is portrayed as being played back in full-screen following the user tapping video 310. The media content device can return to the depiction in FIG. 3 if the playback of the video finishes or if the user provides another gesture (e.g., taps again), or if the user selects a button on the GUI of the application of the mobile device. FIG. 5 illustrate other examples of displaying media content for playback. In FIG. 6, GUI 305 displays different videos because the user has navigated to a different day. Additionally, in FIG. 6, GUI 305 also displays informational labels providing more detailed information regarding video 310, for example, a customized name given it by the user, the date, resolution of the video playback (e.g., 1080p), time duration of playback, the type of camera used to generate video 310, the location from which the video was recorded, and a rating (e.g., the user's own rating, or a rating from social media, as discussed later herein).

Returning to FIG. 2, next the user can indicate that he or she wants to edit the video (220). For example, the user can select a button on the GUI of the application of the mobile device indicating that he or she wants to edit the video, either the one being played back or specifying another video. This can result in the generation of a cut list referencing the video (225) and can be used to indicate portions of the video to be skipped during play back, as discussed regarding cut list 140 in FIG. 1. Additionally, GUI 305 in FIG. 3 can be updated to include a new video corresponding to the cut list. That is, if video 310 is the subject of the user's intention to edit, then video 310 and a version of video 310 to be played back according to the cut list can be displayed in GUI 305. In some implementations, a video that is the result of a cut list in GUI 305 can be displayed or emphasized somewhat differently than the original video. For example, they can have different names, have a different border color, an icon can be displayed in the corner of the image frame for the video with the cut list, etc. As a result, the actual video is not copied; rather, a cut list representing a potential copy of that video is generated and displayed to the user as another video (e.g., a duplicate of the original video 310).

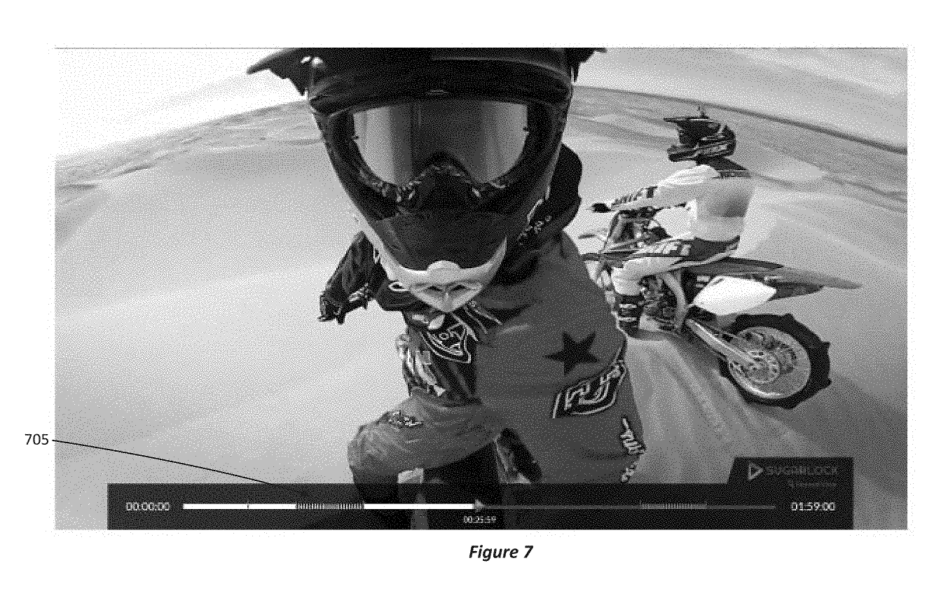

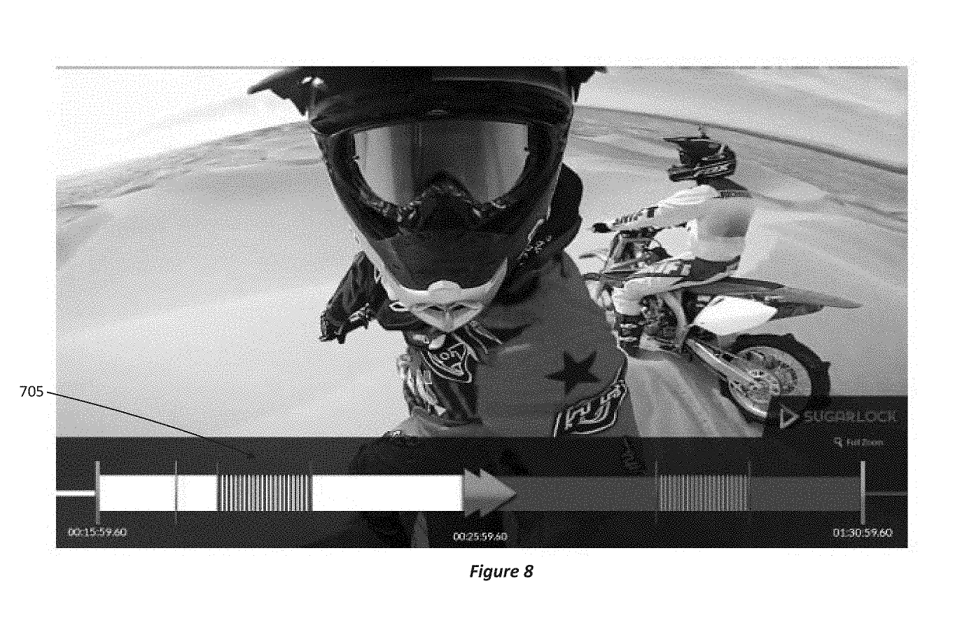

Next, in FIG. 2, gesture data can be generated for editing the video (227). FIG. 7 illustrates an example of editing media content. In FIG. 7, a video with a corresponding cut list can be played back and the user can select cut points to indicate the portions of the playback of the video to be skipped. For example, the user can scrub or navigate through the various image frames of the playback by dragging their finger on the touch screen of the mobile device directionally left to seek backward or directionally right to seek forward. When the user is at the beginning or the end of a portion of the playback that should be skipped from playback, the user can indicate that frame as a cut point. When a portion has a beginning cut point and an ending cut point (or from the beginning of the scrub bar to the first cut point, or the end of the scrub bar to the last cut point), then that portion of the scrub bar can be indicated as being skipped from playback, for example, greyed out as in portion 705 in FIG. 7. This results in the generation of metadata representing the edits to the video (230). For example, cut list 140 in FIG. 1 can be generated by indicating the different portions to be skipped during playback. FIG. 8 illustrates another example of editing media content. In FIG. 8, the scrub bar is magnified for easier observation and editing for the user. That is, when the user is determined to want to generate a cut list, the scrub bar can be enlarged to occupy a larger area of the display screen (e.g., of the television) to allow for easier editing. In some implementations, multiple levels of zoom or magnification of the scrub bar can be provided. For example, the more cut points inserted can result in an increase in the magnification to allow for more accurate placement of cut points. Thus, if the number of cut points increases to a threshold number, then the magnification of the scrub bar can be increased such that it occupies a larger area of the display screen it is displayed upon (e.g., the television).

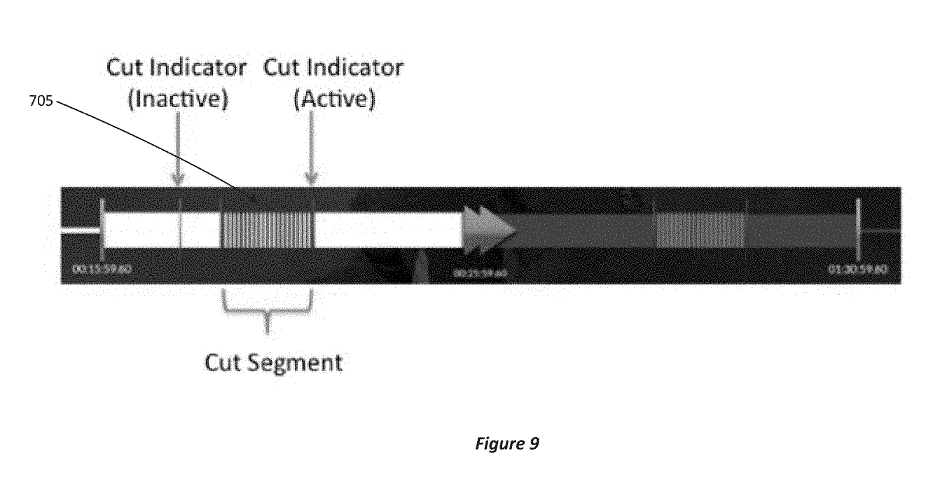

In some implementations, the user can use the mobile device and drag left and/or right, as previously discussed, to navigate through the playback of the video, or scrub bar. After placing the cut points, the user can swipe down to remove the portion from playback in the cut list if the playhead is within the portion. That is, after placing the cut points to indicate portion, the user can move the playhead of the scrub bar to be within the portion and then provide another gesture on the touchscreen of the mobile device to indicate to the media content device that the portion that the playhead is within should be indicated in the cut list as a portion that should be skipped. In some implementations, if the user wants to restore that portion, the user can provide an upward swipe gesture while the playhead is within that portion. This would remove that portion from the cut list. FIG. 9 illustrates an example of a media playback scrub bar with cuts for editing media content. In FIG. 9, portion 705 is portrayed as being in between two other portions that should be played back.

In some implementations, the user can perform additional gestures to aid in the editing of the video. For example, the user can swipe left or right to move the scrub bar (i.e., provide gesture data indicating finger swiping in a particular direction to the media content device). This can allow the movement of the playhead to be stopped upon encountering a cut point. The user can then perform another swipe to resume adjusting the playhead within the scrub bar. This can allow for easier navigation to and within portions that are to be indicated in the cut list.

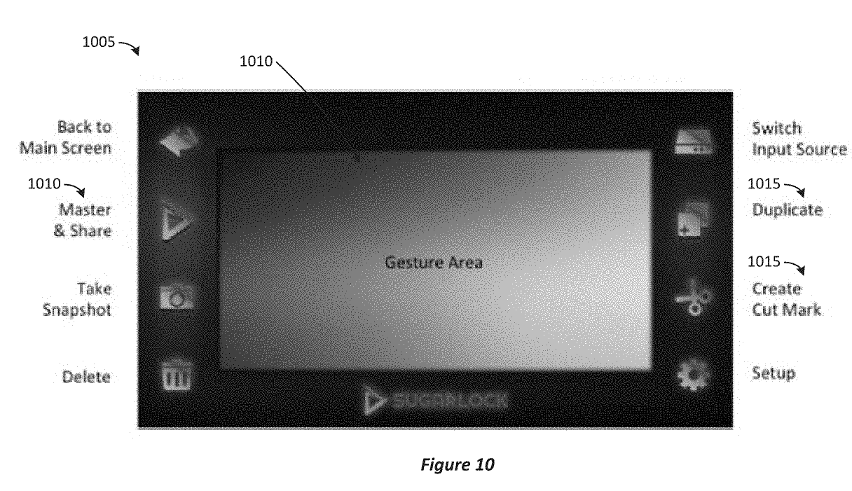

FIG. 10 illustrates an example of a user interface of a mobile device for editing media content. In FIG. 10, GUI 1005 can be provided upon a touchscreen display of a mobile device running an application that the user is using to edit the videos with the media content device. As depicted in FIG. 10, gesture area 1010 can be where the user can input gestures to be provided to the media content device. For example, when GUI 1005 is displayed upon the touchscreen display of the user's mobile device, touches on that touchscreen display above or on gesture area 1010 can be used to determine a user's gestures as discussed herein. Duplicate button 1015 can be selected to generate a cut list referencing a video, as previously discussed and create cut mark button 1020 can be used to select that the position of the playhead should be used as a cut point (i.e., the currently displayed image frame of the playhead should be the cut point), as previously discussed. In some implementations, the gesture area 1010 can also be used for display and generating the cut list of a video. For example, if the user does not have a television available, the gesture area 1010 can be used for both playing back a video as well as gesture input. Thus, by indicating the cut points and, therefore, the portions that should be skipped from playback, the video can viewed with only the portions specified by the user. The next time the user selects the video in GUI 305 in FIG. 3, the metadata of the cut list can be obtained to determine the portions that should be skipped (or the portions that should be played back) and only those portions of the video can be played back. This can be performed while the user thinks that an actual duplicate copy of the video was generated.

Next, returning to FIG. 2, the video can be played back based on the metadata included in the cut list (232). For example, the video can be played back and when the playhead reaches a point in the time duration of playback (e.g., the playback time, such as 8 minutes, 12 seconds into the playback) that should not be played back according to the metadata, then the playhead can be adjusted to skip that portion. That is, the video player provided by the media content device can take into account the metadata of the cut list to skip the portions indicated. In another example, the user can select a video to play back according to a cut list. The video can be played back, and when the video player used by the media content device determines that the playhead has reached an image frame at a playback time that was indicated as one of the cut points and is the beginning of a portion of the playback that should be skipped, then playback can resume at the end of that portion, for example, based on the end of the playback time as indicated in the cut list. Thus, the media content device can determine where in the playback time of the video to skip playback and when to resume playback using the cut list.

In some implementations, the scrub bar provided when playing back the video based on the cut list can portray a shorter time duration of playback than the full video playback. However, in some implementations, the portions that are skipped can be missing from the scrub bar, providing the user with a seamless viewing experience.

Eventually, a video based on the metadata of the cut list can be generated (235). For example, in FIG. 10, the user can select master & share button 1010 to indicate that the cut list and the video should be used to generate a new video only having data for the portions that should be played back. That is, the media content device can master a second version of the video only having the portions that should be played back as indicated by the cut list. This second version of the video can be shorter in time duration (in terms of its playback) than the full version of the video due to the selection of cut points indicating portions that should be skipped from playback. In FIG. 2, the user can publish the video on a social media platform (240). For example, as previously discussed, if the user has provided his or her authentication credentials (e.g., username and password) to a social media account, then the video with the portions cut out from playback when mastered can be uploaded for others to watch. In this way, the user can select the interesting portions of a video, generate a second video with the interesting portions and without the uninteresting portions, and then share the second video with others. In some implementations, mastered videos can be generated from multiple cut lists. This can result in longer videos.

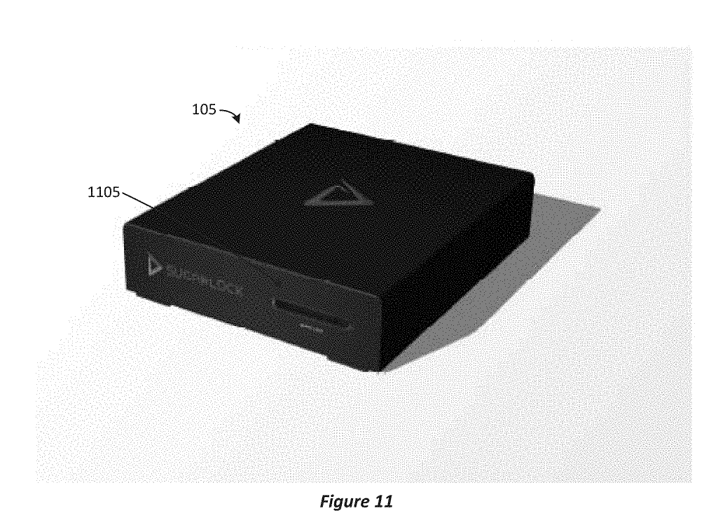

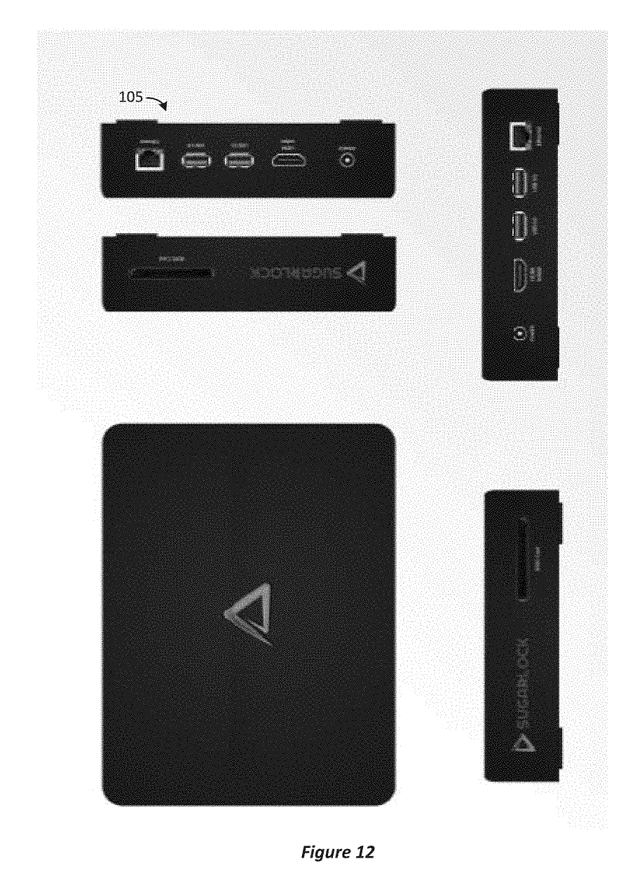

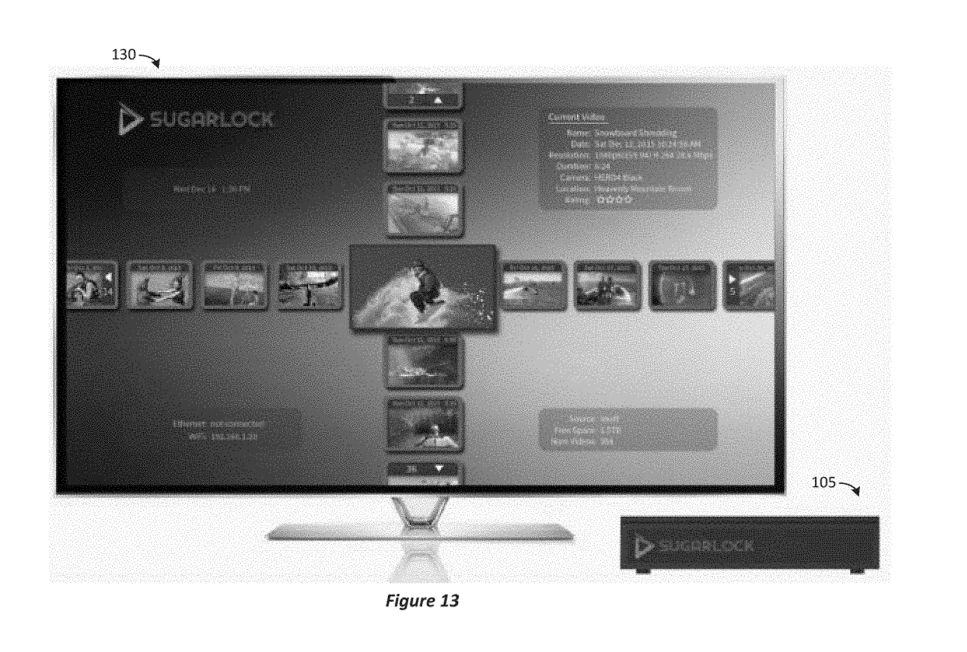

FIG. 11 illustrates an example of a media content device. In FIG. 11, media content device 120 includes memory card slot 1105 that can be used to insert a memory card with videos to be edited and/or played back as discussed herein. FIG. 12 illustrates another example of a media content device. FIG. 12 shows the back of media content device 120 including a variety of ports such as an HDMI port that can be used to connect with a television, as previously described. FIG. 13 illustrates an example of a media content device providing playback of media content on a television. For example, if media content player 105 is connected with television 130, then video data can be provided by media content 105 to television 130 for display.

In some implementations, the user can upload the videos onto a cloud server, for example, accessible over the Internet. For example, when a microSD card is inserted into the media content device, it can upload some or all of the videos to a cloud-based archive. In some implementations, the media content device can upload new videos to the cloud-based archive so that duplicates are not uploaded.

In some implementations, the user can generate cut lists using videos stored in the cloud. For example, the user's video camera might generate videos at a relatively high resolution. These can eventually be archived into a cloud-based server. However, if the user wants to use those high resolution videos to generate the cut lists on the media content device, this can take a significant amount of time due to the large file sizes of high resolution videos. Thus, in some implementations, the cloud-based server can receive or encode videos it receives at high resolutions at lower resolutions. As an example, if the cloud-based server receives a 4K resolution video (e.g., 3840 pixels in the horizontal resolution and 2160 pixels in the vertical resolution), this can be a relatively large file size to upload and download. The cloud-based server can encode that 4K resolution video that it receives to a lower resolution, for example 1080p or 720p. The lower resolution video file would have a lower bit rate and therefore a lower file size than the 4K resolution video. Thus, if the user indicates that he or she wishes to generate a cut list for the 4K resolution video, the cloud-based server can determine that there is actually a lower resolution version of that video available and provide that to the user. This allows for a lower resolution version of the video to be streamed or downloaded to the user and the user can easily navigate through the scrub bar and select cut points without video buffering or other setbacks that can result if using the higher bit rate 4K resolution video. The cut list can then be generated by the media content device and that cut list can then be provided to the cloud-based server. Upon receiving the cut list, the cloud-based server can then generate a second version of the 4K resolution video based on the cut list (e.g., having fewer portions for playback than the original 4K resolution video). As a result, the user can quickly and easily edit the 4K resolution video using a lower resolution video. In some implementations, the aforementioned techniques can performed on and by media content device 120.

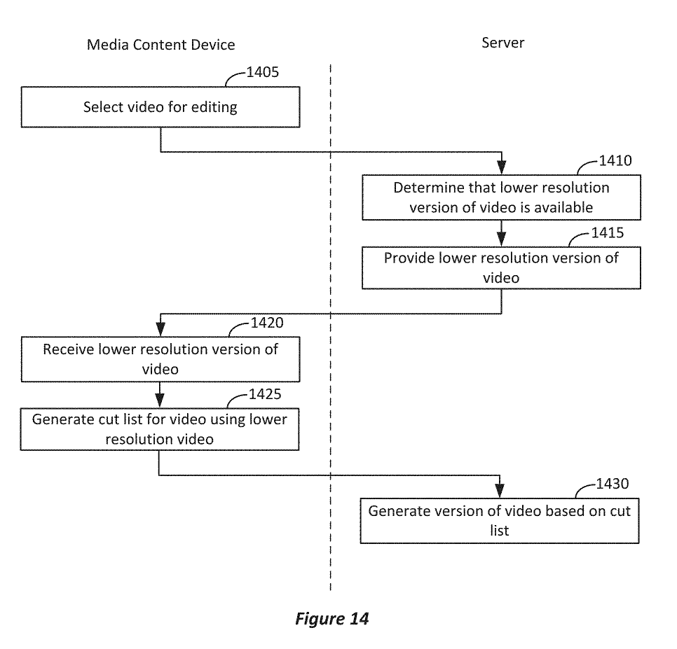

FIG. 14 illustrates a block diagram for cloud-based editing of media content. In FIG. 14, a high-resolution video can have been previously uploaded to a cloud-based server. Upon determination that the video is within a certain resolution or quality range resulting in a fairly large video (e.g., 4K or higher, at a bit rate above a threshold bit rate, etc.), the cloud-based server can generate a lower resolution version of that video. Eventually, the user can then indicate or select the high-resolution video for editing (1405). The cloud-based server can receive that request, determine that it's for a video at a high resolution, and determine that a lower resolution version of that video is available (1410) and provide that to the media content device (1415). The media content device can receive the lower resolution version of the video (1420) and the user can use that to generate the cut list for the video (1425). That is, the cut list for the higher resolution video can be generated using the lower resolution video. The cut list can then be provided to the cloud-based server and it can generate another version of the higher resolution video based on the cut list (1430). For example, the other version can have the same resolution, but can skip playback of the portions based on the metadata in the cut list, as previously discussed.

In some implementations, the user might set up the media content device within his home with a television, for example, by setting up the network authentication so that the home's wireless network is available for it to access the Internet. However, some times the user might take the media content device with him or her to their car, for example, at the beach where they might want to generate cut lists right after surfing. Thus, the user can be provided the display including the scrub bar on the mobile device and use that with the media content device to generate the cut lists without the use of another display device such as a television. In some implementations, the mobile device and the media content device can communicate with each other through a sideband communication (e.g., over Bluetooth) when the mobile device cannot detect the home's wireless network. For example, the media content device can broadcast its own network when it is outside of the range of the home's wireless network and the mobile device can then connect to that network to provide the features disclosed herein.

In some implementations, a cloud service can be used to upgrade the media content device to add new features, fix bugs, etc. In some implementations, the cloud service can determine whether the media content needs a full or partial software upgrade and provides updates providing the necessary upgrades.

In some implementations, the mobile device determines that the user has provided gestures and converts those gestures into polar coordinates relevant (e.g., scaled) to the geometry of the gesture area of the phone (e.g., a rectangle of a particular dimension). Data representing the polar coordinates can then be provided to the media content device and it can scale the coordinates based on the size of the television screen that it is connected with.

In some implementations, if the video is being played back in full screen for editing (e.g., generating cut lists), the gestures can correspond to any portion of the screen, allowing for editing without having to select small buttons.

In some implementations, when a video is deleted using the media content device, this might leave other files, for example, metadata regarding that video that was generated by the video camera used to make the video. Thus, the media content device can determine that a video was requested to be deleted, delete that video, and also determine other related files of that video (e.g., metadata, lower resolution versions of that video, still image frames from that video, etc.) and delete those to conserve memory capacity on the microSD card or other storage device storing the videos.

In some implementations, the media content device can perform operations on the microSD card (or other storage device) and mark it as “dirty” indicating that there might be pending writes (e.g., store more data) on the card. In some implementations, all file system writes can begin with indicating the card as dirty, perform the write operation, and then indicate the card as “clean.” The next write operation can then subsequently indicate the card as “dirty,” perform the write operation, and then indicate the card as “clean,” and so forth. This can ensure that the card is always or usually marked as “clean” and therefore users do not have to unmount the card using lengthy or complicated procedures. Additionally, if the card is later inserted into a computer, the operating system of that computer would recognize the card as clean and not provide any errors or warnings regarding the state of the card being dirty.

In some implementations, an application programming interface (API) for client interactions to access videos on the card inserted into the media content device can be provided. In some implementations, the client can transmit its configuration information on a sideband communication to the media content device so that it does not have to use a web service to do the configuration.

In some implementations, the media content device can be an Internet of Things (IoT) device that can communicate with other IoT devices. The other IoT devices might not have the capability to generate a user interface (e.g., no display screen). If so, the media content device can generate a UI for that IoT device and provide it to a user using a mobile device. In some implementations, the media content device can transfer various assets to the mobile device so that it can generate the UI. The mobile device can then be used to control the IoT using the UI.

In some implementations, the media content device can scale UI elements using fixed art dimensions to fit the screen size and/or capabilities of the television (or other display screens it is using).

In some implementations, the media content device can publish the edited videos to several social media platforms or communications channels upon the selection of a single button. For example, the user can select user preferences indicating what social media services, messenger programs, email, text messaging, etc. can be used to share videos. In some implementations, analytics regarding the shared videos on the various platforms can also be determined, for example, how well others enjoyed the videos (e.g., indicating as “liking” the video), comments posted regarding the videos, etc.

In some implementations, metadata regarding videos stored on the card inserted into the media content device can be uploaded to a cloud server. The user can then edit that metadata, for example, changing the names of the videos, giving the videos ratings, etc. That edited metadata can then be downloaded by the media content device and the old metadata can be updated. As a result, when the user access the videos on the card again, they can see the new metadata.

In some implementations, a cloud-based video editing service can also be offered. For example, an open platform for transactions can be available where users can request others to generate the cut lists for their videos.

Many of the examples described herein include a mobile device having a touchscreen such as a smartphone or tablet. However, in other implementations, the mobile device can be a remote control. Many of the examples described herein also describe video as media content to be played back, manipulated, and edited. However, the examples can also be used for other types of media content including audio and images. Additionally, many of the examples described herein use a stand-alone media content device. However, in some implementations, the functionality and features described herein can be integrated into other products, for example, action cameras, video cameras, digital single-lens reflex (DSLR) cameras, drones, etc.

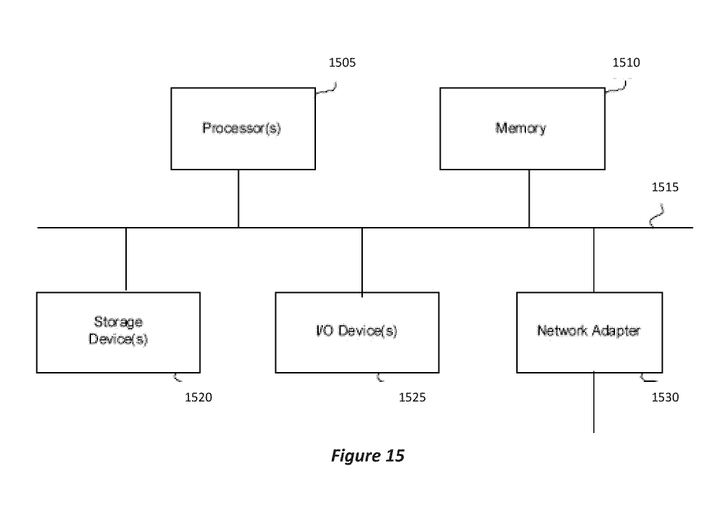

FIG. 15 illustrates an example of a media content device. FIG. 16 is a block diagram of a computer system as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, television, monitor, or any machine capable of executing a set of instructions (sequential or otherwise) that specify actions to be taken by that machine.

The computing system may include one or more central processing units (“processors”) 1505, memory 1510, input/output devices 1525 (e.g., keyboard and pointing devices, touch devices, display devices), storage devices 1520 (e.g., disk drives), and network adapters 1530 (e.g., network interfaces) that are connected to an interconnect 1515. The interconnect 1515 is illustrated as an abstraction that represents any one or more separate physical buses, point to point connections, or both connected by appropriate bridges, adapters, or controllers. The interconnect 1515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The memory 1510 and storage devices 1520 arc computer-readable storage media that may store instructions that implement at least portions of the various embodiments. In addition, the data structures and message structures may be stored or transmitted via a data transmission medium, e.g., a signal on a communications link. Various communications links may be used, e.g., the Internet, a local area network, a wide area network, or a point-to-point dial-up connection. Thus, computer readable media can include computer-readable storage media (e.g., “non-transitory, media) and computer-readable transmission media.

The instructions stored in memory 1510 can be implemented as software and/or firmware to program the processor(s) 1505 to carry out actions described above. In some embodiments, such software or firmware may be initially provided to the processing system by downloading it from a remote system through the computing system (e.g., via network adapter 1530).

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Those skilled in the art will appreciate that the logic and process steps illustrated in the various flow diagrams discussed herein may be altered in a variety of ways. For example, the order of the logic may be rearranged, sub-steps may be performed in parallel, illustrated logic may be omitted, other logic may be included, etc. One will recognize that certain steps may be consolidated into a single step and that actions represented by a single step may be alternatively represented as a collection of substeps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed, scrambled and/or encrypted; etc.

From the foregoing, it will be appreciated that specific embodiments of the invention have been described herein for purposes of illustration, but that various modifications can be made without deviating from the scope of the invention. Accordingly, the invention is not limited except as by the appended claims.

I/We claim:

1. An electronic device, comprising:
one or more processors; and
memory storing instructions, wherein the one or more processors are configured to execute the instructions such that the one or more processors and memory are configured to:
play back a first video;
receive input representing one or both of a beginning or end of a playback time of a portion of the first video within a playback of the first video that should be excluded from playback;
generate a cut list including metadata referencing that the portion of the first video should be excluded from playback; and
play back the first video without playing back the portion based on the metadata included in the cut list.

2. The electronic device of claim 1, wherein a time duration of playback of the portion is less than a time duration of playback of the first video.

3. The electronic device of claim 1, wherein the one or more processors are configured to execute the instructions such that the one or more processors and memory are configured to:
generate a second video based on the first video and the metadata included in the cut list, the second video excluding the portion of the first video, playback of the second video being shorter in time duration than playback of the first video.

4. The electronic device of claim 3, wherein the one or more processors are configured to execute the instructions such that the one or more processors and memory are configured to:
publish the second video to one or more of a social media service, a messenger program, email, or text messaging.

5. The electronic device of claim 1, wherein the one or more processors are configured to execute the instructions such that the one or more processors and memory are configured to:
provide, on a graphical user interface (GUI), a first depiction representing the first video; and
provide, on the GUI, a second depiction representing playback of the first video based on the cut list.

6. The electronic device of claim 5, wherein the second depiction includes visual content differentiating the second depiction as being based on the cut list in comparison to the first depiction.

7. An electronic device, comprising:
one or more processors; and
memory storing instructions, wherein the one or more processors are configured to execute the instructions such that the one or more processors and memory are configured to:
receive input representing one or both of a beginning or end of a playback time of a portion of a first media content within a playback time of the first media content that should be excluded from playback;
generate a cut list including metadata referencing that the portion of the first media content should be excluded from playback; and
play back the first media content without playing back the portion based on the metadata included in the cut list.

8. The electronic device of claim 7, wherein the first media content is a video.

9. The electronic device of claim 7, wherein a time duration of playback of the portion is less than a time duration of playback of the media content.

10. The electronic device of claim 7, wherein the one or more processors are configured to execute the instructions such that the one or more processors and memory are configured to:
generate a second media content based on the first media content and the metadata included in the cut list, the second media content excluding the portion of the first media content, playback of the second video being shorter in time duration than playback of the first media content.

11. The electronic device of claim 10, wherein the one or more processors are configured to execute the instructions such that the one or more processors and memory are configured to:
publish the second media content to one or more of a social media service, a messenger program, email, or text messaging.

12. The electronic device of claim 11, wherein publishing the second media content to the one or more of a social media service, a messenger program, email, or text messaging includes receiving account credentials from a mobile device used to provide the input.

13. The electronic device of claim 7, wherein the one or more processors are configured to execute the instructions such that the one or more processors and memory are configured to:
provide, on a graphical user interface (GUI), a first depiction representing the first media content; and
provide, on the GUI, a second depiction representing playback of the first media content based on the cut list.

14. The electronic device of claim 13, wherein the second depiction includes visual content differentiating the second depiction as being based on the cut list in comparison to the first depiction.

15. A method for playing back media content, comprising:
receiving input representing one or both of a beginning or end of a playback time of a portion of a first media content within a playback time of the first media content that should be excluded from playback;
generating, by a processor, a cut list including metadata referencing that the portion of the first media content should be excluded from playback; and
playing back the first media content without playing back the portion based on the metadata included in the cut list.

16. The method of claim 15, wherein the first media content is a video.

17. The method of claim 15, wherein a time duration of playback of the portion is less than a time duration of playback of the media content.

18. The method of claim 15, further comprising:
generating a second media content based on the first media content and the metadata included in the cut list, the second media content excluding the portion of the first media content, playback of the second video being shorter in time duration than playback of the first media content.

19. The method of claim 18, further comprising:
publishing the second media content to one or more of a social media service, a messenger program, email, or text messaging.

20. The method device of claim 19, wherein publishing the second media content to the one or more of a social media service, a messenger program, email, or text messaging includes receiving account credentials from a mobile device used to provide the input.

21. The method of claim 15, further comprising:
providing, on a graphical user interface (GUI), a first depiction representing the first media content; and
providing, on the GUI, a second depiction representing playback of the first media content based on the cut list.

22. The method of claim 20, wherein the second depiction includes visual content differentiating the second depiction as being based on the cut list in comparison to the first depiction.
